(19) United States
(12) Patent Application Publication
(10) Pub. No.: US 2014/0317499 A1
(43) Pub. Date: Oct. 23, 2014

(54) APPARATUS AND METHOD FOR CONTROLLING LOCKING AND UNLOCKING OF PORTABLE TERMINAL

(71) Applicant: Samsung Electronics Co., Ltd., Gyeonggi-do (KR)

(72) Inventors: Hun-Cheol OH, Seoul (KR); Yu-Jin Lee, Gyeonggi-do (KR); Dong-Ho Jang, Gyeonggi-do (KR); Bo-Seul Jeon, Gyeonggi-do (KR)

(73) Assignee: Samsung Electronics Co., Ltd., Gyeonggi-do (KR)

(21) Appl. No.: 14/258,455

(22) Filed: Apr. 22, 2014

(30) Foreign Application Priority Data
Apr. 22, 2013 (KR) 10-2013-0044279

(51) Int. Cl. G06F 3/0481; G06F 3/0488; G06F 3/16; G06F 3/0484; G06F 3/01

(52) U.S. Cl. CPC G06F 3/04815; G06F 3/0484; G06F 3/0481; G06F 3/016; G06F 3/16; G06F 3/0488
USPC 715/702; 715/781; 715/768

(57) ABSTRACT

A portable terminal and a method for controlling locking and unlocking of a touch screen are provided. The method of unlocking a portable terminal includes displaying a three dimensional (3D) lock screen recognized in 3D on a screen, and determining a locking state of the portable terminal based on a spatial gesture input when the spatial gesture input is detected on the 3D lock screen.

### PRIORITY

This application claims priority under 35 U.S.C. §119(a) to Korean Application Serial No. 10-2013-0044279, which was filed in the Korean Intellectual Property Office on Apr. 22, 2013, the contents of are incorporated herein by reference.

### BACKGROUND OF THE INVENTION

1. Field of the Invention

The present invention relates generally to a portable terminal, and more particularly, to an apparatus and a method for controlling locking and unlocking of a portable terminal.

2. Description of the Related Art

The portable terminal has evolved to provide various services in addition to conventional voice call services. In order to increase an effective value of the portable terminal and meet various user demands, a variety of applications which can be executed in the portable terminal have been developed.

Hundreds of applications may be stored in the portable terminal such as a smart phone and a tablet Personal Computer (PC). Objects (or shortcut icons) for executing the respective applications are displayed on a screen of the portable terminal. The use of touch screens is continuously increasing, and portable terminals implementing such screens can be locked or unlocked using the screen. That is, when a predetermined lock condition is satisfied, the portable terminal enters a locked state and operations thereof are restricted. When a specific condition is met, the portable terminal in the locked state provides a lock screen using a user interface. Such a condition includes an input of a specific key, a call, arrival of a message such as a Short Message Service (SMS) and a Multimedia Message Service (MMS), and an alarm signaling a status of the portable terminal.

In order to unlock the portable terminal, a user inputs a preconfigured gesture to the screen or inputs a predetermined key or password after a lock screen is displayed on the portable terminal. For example, the portable terminal provided with the screen outputs an image for requiring an input of a specific pattern, determines whether a pattern identical to a previously input pattern is drawn, and if such a pattern is drawn, enters a home screen or menu screen.

However, while the portable terminal may be easily and rapidly unlocked by the method of releasing the lock using the pattern of the gesture on the screen, a user's motion of inputting the password may be easily recognized. Furthermore, since the pattern is drawn on the screen in a contact manner, a drawing mark is left on the screen, which enables other people to easily discern the pattern.

### SUMMARY OF THE INVENTION

The present invention has been made to address at least the above-mentioned problems and/or disadvantages in the prior art and to provide at least the advantages described below.

Accordingly, an aspect of the present invention is to provide an unlocking method which a user can more conveniently manipulate and various unlocking methods provided according to a security level.

Another aspect of the present invention is to provide an effective unlock user interface method suitable for characteristics of a portable terminal equipped with various functions and specifications.

Another aspect of the present invention is to provide a portable terminal and a method for controlling locking and unlocking operations, in which a locked state can be released through a user's 3DDimensional (3D) interface input, thereby achieving improved security functions.

In accordance with an aspect of the present invention, a method for unlocking a portable terminal includes displaying a 3D lock screen recognized in 3D on a screen, and determining a locking state of the portable terminal based on a spatial gesture input if the spatial gesture input is detected on the 3D lock screen.

In accordance with another aspect of the present invention, a portable terminal for unlocking a touch screen includes a screen configured to display a 3D lock screen recognized in 3D by a user and a controller configured to control a locking state of the portable terminal based on a spatial gesture input if the spatial gesture input is detected on the 3D lock screen.

In accordance with another aspect of the present invention, a method for locking a portable terminal includes displaying a 3D lock screen recognized in 3D on a screen to lock the portable terminal, and determining a lock configuration of the portable terminal based on a spatial gesture input if the spatial gesture input is detected on the 3D lock screen.

In accordance with another aspect of the present invention, a portable terminal for locking a touch screen includes a screen configured to display a 3D lock screen recognized in 3D in response to a menu that is executed to lock the portable terminal, and a controller configured to determine a lock configuration of the portable terminal based on a spatial gesture input when the spatial gesture input is detected on the 3D lock screen.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a portable terminal according to an embodiment of the present invention;

FIG. 2 illustrates a front perspective view of the portable terminal according to the embodiment of the present invention;

FIG. 3 is a rear perspective view of the portable terminal according to the embodiment of the present invention;

FIG. 4 illustrates an input unit and an internal structure of a touch screen according to an embodiment of the present invention;

FIG. 5 illustrates an input unit according to an embodiment of the present invention;

FIG. 6 illustrates a process of unlocking a portable terminal by inputting a pattern to a lock screen displayed as a 3D image according to an embodiment of the present invention;

FIG. 7A illustrates an example of displaying a 3D image for unlocking the portable terminal on a touch screen according to an embodiment of the present invention;

FIG. 7B illustrates an example of inputting a pattern for unlocking the portable terminal to the 3D image displayed on the touch screen according to an embodiment of the present invention;

FIG. 7C illustrates an example in which the pattern for unlocking the portable terminal is completely input to the 3D image displayed on the touch screen according to an embodiment of the present invention;

FIG. 7D illustrates an example of a state in which the portable terminal is unlocked by completing the input of the pattern for the unlocking to the 3D image displayed on the touch screen according to an embodiment of the present invention; and

FIGS. 8A to 8C illustrate examples of a disparity according to a focus position where a user keeps eyes focused on a touch screen according to an embodiment of the present invention.

### DETAILED DESCRIPTION OF EMBODIMENTS OF THE INVENTION

The present invention may have various modifications and various embodiments, among which specific embodiments will now be described more fully with reference to the accompanying drawings. However, it should be understood that there is no intent to limit the present invention to the specific embodiments, but on the contrary, the present invention covers all modifications, equivalents, and alternatives falling within the scope of the disclosure. Descriptions of well-known functions and constructions may be omitted for the sake of clarity and conciseness.

Although the terms including an ordinal number such as first and second can be used for describing various elements, the elements are not restricted by the terms. The terms are only used to distinguish one element from another element. For example, without departing from the scope of the present invention, a first structural element may be named a second structural element. Similarly, the second structural element also may be named the first structural element. As used herein, the term “and/or” includes any and all combinations of one or more of the associated listed items.

Terms to be used in the present invention will be defined as follows.

Portable terminal: A device that can perform data transmission/reception, a voice call, and a video call while being carried, and may be provided with one, two or more screens (or touch screens). Such a portable terminal includes devices such as a smart phone, a tablet Personal Computer (PC), a 3D-TeleVision (TV), a smart TV, a Light Emitting Diode (LED) TV, a Liquid Crystal Display (LCD) TV, and in addition to those devices, includes terminals that can communicate with peripheral devices or other terminals located in a long range.

Input unit: A component that includes at least one of a finger, an electronic pen, and a stylus pen which can provide commands or inputs to the portable terminal in the state of contact on a screen or in the state of non-contact such as hovering over the screen.

Object: A representation that is displayed or may be displayed on a screen and includes at least one of a document, a widget, a photo, a video, an e-mail, letter paper, a Short Message Service (SMS) message, and a Multimedia Message Service (MMS) message, and may be executed, deleted, cancelled, stored, and modified by the input unit. Such an object may also include a shortcut icon, a thumbnail image, and a folder storing at least one object in the portable terminal.

Shortcut icon: A representation that is displayed on the screen of the portable terminal for a quick launch of an application or a phone-call, a contact, or a menu, for example. When a command or input for executing the shortcut icon is input, the corresponding application is executed.

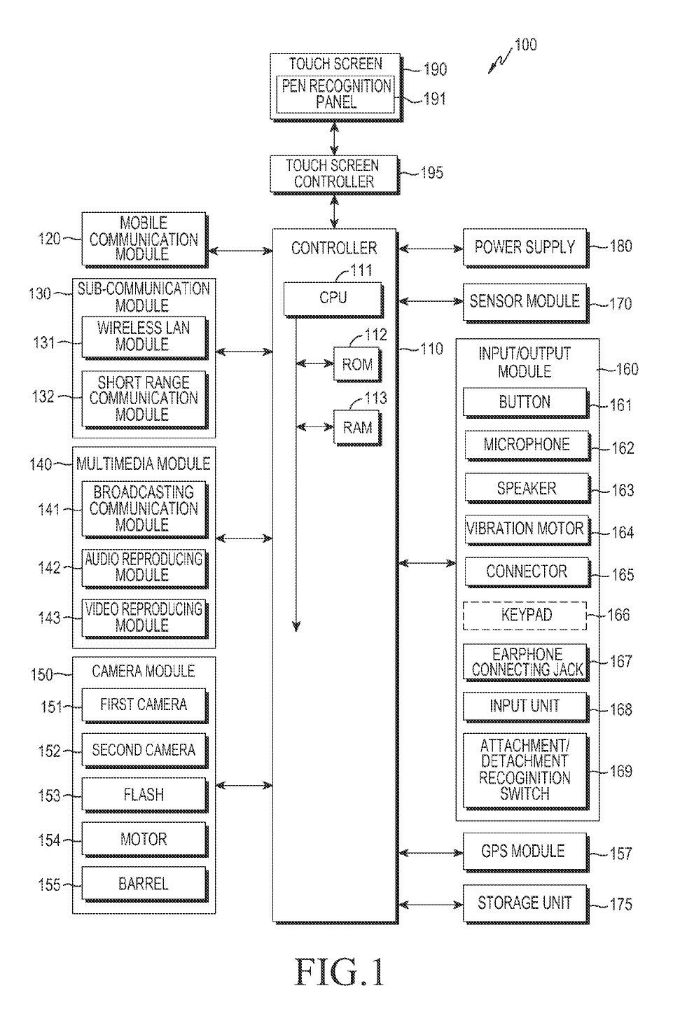

FIG. 1 illustrates a portable terminal according to an embodiment of the present invention.

Referring to FIG. 1, a portable terminal 100 may be connected with an external device (not illustrated) by using at least one of a mobile communication module 120, a sub-communication module 130, a connector 165, and an earphone connecting jack 167. The external device includes various devices detachably attached to the portable terminal 100 in a wired manner, such as earphones, an external speaker, a Universal Serial Bus (USB) memory, a charger, a cradle/dock, a Digital Multimedia Broadcasting (DMB) antenna, a mobile payment related device, a health management device (a blood sugar tester or the like), a game machine, and a car navigation device. The external device includes a Bluetooth® communication device, a Near Field Communication (NFC) device, a Wi-Fi Direct communication device, and a wireless Access Point (AP), which can be connected with the portable terminal in a wireless manner. The portable terminal may be connected with other devices, such as a cellular phone, a smart phone, a tablet PC, a desktop PC, and a server in a wired or wireless manner.

Referring to FIG. 1, the portable terminal 100 includes at least one touch screen 190 and at least one touch screen controller 195. Locking and unlocking operations according to the present invention are also employed for a screen capable of detecting an input of a touch and/or hovering using an input unit, and the screen includes a touch screen. The portable terminal 100 includes a controller 110, the mobile communication module 120, the sub-communication module 130, a multimedia module 140, a camera module 150, a Global Positioning System (GPS) module 157, an input/output module 160, a sensor module 170, a storage unit 175, and a power supply unit 180.

The sub-communication module 130 includes at least one of a wireless Local Area Network (LAN) module 131 and a short range communication module 132, and the multimedia module 140 includes at least one of a broadcasting communication module 141, an audio reproducing module 142, and a video reproducing module 143. The camera module 150 includes at least one of a first camera 151 and a second camera 152. The camera module 150 of the portable terminal 100 according to the present invention includes at least one of a barrel 155 for zooming in/zooming out the first and/or second cameras 151 and 152, a motor 154 for controlling a motion of the barrel 155 to zoom in/zoom out the barrel 155, and a flash 153 for providing a light source for photographing according to a main purpose of the portable terminal 100. The input/output module 160 includes at least one of a button 161, a microphone 162, a speaker 163, a vibration motor 164, a connector 165, and a keypad 166.

The control unit 110 includes a Central Processing Unit (CPU) 111, a Read Only Memory (ROM) 112 storing control programs for controlling the user terminal 100, and a Random Access Memory (RAM) 113 which stores signals or data input from the outside of the user terminal 100 or is used as a memory region for tasks executed in the user terminal 100. The CPU 111 may include a single core, a dual core, a triple core, or a quad core. The CPU 111, the ROM 112 and the RAM 113 may be connected with each other through internal buses.

The controller 110 controls the mobile communication module 120, the sub-communication module 130, the multimedia module 140, the camera module 150, the GPS module 157, the input/output module 160, the sensor module 170, the storage unit 175, the power supply unit 180, the touch screen 190, and the touch screen controller 195.

The controller 110 may detect various user inputs received through the camera module 150, the input/output module 160, and the sensor module 170 as well as the touch screen 190. The user inputs include various types of information input to the portable terminal, such as a gesture, a voice, a pupil action, and a bio signal of a user as well as the touch. The controller 110 controls such that predetermined operations or functions corresponding to the detected user inputs are performed within the portable terminal.

While a plurality of objects are being displayed on the touch screen 190, the controller 110 determines whether hovering is recognized when a touchable input unit 168 such as an electronic pen closely approaches any one object or whether the input unit 168 touches the touch screen 190. The controller 110 may detect a height from the portable terminal 100 to the input unit 168 and a hovering input according to the height. That is, the controller 110 detects the hovering input of the input unit 168 over the touch screen 190 or the touch input generated by a touch or drawing of the input unit 168 on the touch screen 190.

The controller 110 determines a locking state for the portable terminal based on a spatial gesture input if the spatial gesture input is detected on a 3D lock screen when the 3D lock screen recognized in 3D is being displayed. The controller 110 analyzes the spatial gesture input based on 3D coordinate information of the 3D lock screen displayed on the screen. The 3D lock screen displayed on the screen is an image recognized in 3D due to the user's binocular disparity and is focused on a front or rear side of the screen. The controller 110 detects a pattern or a spatial gesture input which is input to unlock the portable terminal, and compares the detected pattern with a pre-stored unlocking pattern. The controller 110 compares 3D coordinates of the spatial gesture input with 3D coordinates of the unlocking pattern. The unlocking pattern may be stored in advance. The controller 110 determines unlocking of the 3D lock screen according to a result of the comparison. If the detected pattern is not in accordance with the pre-stored unlocking pattern, the controller 110 maintains the portable terminal in the locked state and outputs a result corresponding to the discord. Such an output result includes at least one of a sound, a vibration, a text, and a popup window, and in addition, includes various methods which the user can recognize.

The controller 110 detects a pattern or a spatial gesture input which is input to lock the portable terminal on the 3D lock screen which is displayed on the touch screen, executed to lock the portable terminal, and recognized in 3D, and controls storage of the detected pattern or spatial gesture input. The controller 110 determines locking of the portable terminal based on the spatial gesture input. The pattern for locking the portable terminal includes a gesture that is input in 3D with respect to a user's eyes in at least one space of front and rear sides of the portable terminal. The gesture includes a spatial gesture, and is detected using at least one of a camera that is provided to the portable terminal and photographs a 3D image, a proximity sensor that measures a distance away from the portable terminal, and a hovering sensor. The controller 110 displays a trace according to a progress direction of the detected pattern or spatial gesture input on the 3D lock screen. The controller 110 outputs a result for the spatial gesture input, in which the output result includes at least one of a change in a color, a sound, and haptic feedback. The controller 110 displays the trace of the spatial gesture input on the 3D lock screen. The controller 110 outputs at least one of a change in a color of at least one portion of the 3D lock screen, a sound, and haptic feedback while displaying the trace.

The controller 110 receives, from the touch screen controller 195, a moving distance and a moving direction of a finger or input unit on the touch screen 190 or on a front or rear surface of the portable terminal 100, and displays the received moving distance and direction as a series of a pattern on the screen. A position of a starting point of the pattern may be recognized by various methods such as changing a color of the starting point, outputting a sound, and providing haptic feedback. In addition, the controller 110 receives a result of a comparison between positions of a lock setting point and a finger or input unit from the touch screen controller 195, and determines to lock or unlock the portable terminal or to maintain the portable terminal in the locked state. The pattern for unlocking the portable terminal includes a gesture that is input in 3D by using the input unit in at least one space of the front and rear sides of the portable terminal. The gesture is detected using at least one of a camera that is provided to the portable terminal and photographs a 3D image, a proximity sensor that measures a distance away from the portable terminal, and a hovering sensor.

The controller 110 outputs a result for a progress direction of the detected pattern, in which the output result includes at least one of a color, a sound, and haptic feedback. The controller 110 detects the gesture using at least one of a camera, a proximity sensor, and a hovering sensor in units of predetermined time intervals, and analyzes spatial depth information on the 3D lock screen displayed on the touch screen. The spatial depth information is analyzed by a disparity of a user's eyes on the 3D lock screen displayed on the touch screen, and includes a positive disparity and a negative disparity. The controller 110 compares 3D coordinates collected for a moving path of the input pattern at a predetermined time interval with 3D coordinates of points of the displayed 3D lock screen.

The mobile communication module 120 enables the portable terminal 100 to be connected with the external device through mobile communication by using one or more antennas under the control of the controller 110. The mobile communication module 120 transmits/receives a wireless signal for a voice call, a video call, an SMS, or a Multimedia Message Service (MMS) to/from a mobile phone (not illustrated), a smart phone (not illustrated), a tablet PC, or another device (not illustrated), which has a phone number input to the portable terminal 100.

The sub-communication module 130 includes at least one of the wireless LAN module 131 and the short range communication module 132. For example, the sub-communication module 130 includes only the wireless LAN module 131, only the short-range communication module 132, or both the wireless LAN module 131 and the short-range communication module 132.

The wireless LAN module 131 may be connected to the Internet in a place where a wireless Access Point (AP) (not illustrated) is installed, under the control of the controller 110. The wireless LAN module 131 supports a wireless LAN standard (IEEE802.11x) of the Institute of Electrical and Electronics Engineers (IEEE). The short range communication module 132 may wirelessly perform short range communication between the portable terminal 100 and an image forming apparatus (not illustrated) under the control of the controller 110. A short range communication scheme includes a Bluetooth® communication scheme, an Infrared Data Association (IrDA) communication scheme, a WiFi-Direct communication scheme, and a Near Field Communication (NFC) scheme for example.

According to the performance, the portable terminal 100 includes at least one of the mobile communication module 120, the wireless LAN module 131, and the short range communication module 132, which are referred to herein as a transmitter/receiver.

The multimedia module 140 includes the broadcasting communication module 141, the audio reproducing module 142, or the video reproducing module 143. The broadcasting communication module 141 may receive a broadcasting signal (e.g., a TV broadcasting signal, a radio broadcasting signal, or a data broadcasting signal) or broadcasting additional information (e.g., Electric Program Guide (EPS) or Electric Service Guide (ESG)) which are transmitted from a broadcasting station through a broadcasting communication antenna (not illustrated) under the control of the controller 110. The audio reproducing module 142 may reproduce a stored or received digital audio file (e.g., a file having a file extension of mp3, wma, ogg, or way) under the control of the controller 110. The video reproducing module 143 may reproduce a stored or received digital video file (e.g., a file having a file extension of mpeg, mpg, mp4, avi, mov, or mkv) under the control of the controller 110. The video reproducing module 143 may reproduce a digital audio file.

The multimedia module 140 includes the audio reproducing module 142 and the video reproducing module 143 except for the broadcasting communication module 141. The audio reproducing module 142 or the video reproducing module 143 of the multimedia module 140 may be included in the controller 110.

The camera module 150 includes at least one of the first camera 151 and the second camera 152 which photograph a still image or a moving image under the control of the controller 110. The camera module 150 includes at least one of the barrel 155 performing a zoom-in/out for photographing a subject, the motor 154 controlling a movement of the barrel 155, and the flash 153 providing an auxiliary light source required for photographing the subject. The first camera 151 may be disposed on a front surface of the portable terminal 100, and the second camera 152 may be disposed on a rear surface of the portable terminal 100. Alternatively, the first camera 151 and the second camera 152 are arranged adjacent to each other (e.g., an interval between the first camera 151 and the second camera 152 is between 1 cm and 8 cm) to photograph a 3D still image or a 3D moving image. At least one of the first camera 151 and the second camera 152 may analyze a point toward which a user's eyes currently orient, by photographing a focus of the user's eyes. That is, at least one of the first camera 151 and the second camera 152 identifies whether the focus of the user's eyes orients toward a positive disparity, an arbitrary point, or a negative disparity on the touch screen 190. As described above, the camera module 150 may receive the position of the user's eyes or the position and motion of a finger or input unit.

The first and second cameras 151 and 152 include a lens system and an image sensor. The first and second cameras 151 and 152 may convert optical signals input (or taken) through the lens system into electric image signals, and may output the electric image signals to the controller 110. A user takes a video or a still image through the first and second cameras 151 and 152.

The GPS module 157 may receive radio waves from a plurality of GPS satellites (not illustrated) in Earth's orbit, and may calculate a position of the portable terminal 100 by using Time of Arrival information from the GPS satellites to the portable terminal 100.

The input/output module 160 includes at least one of a plurality of buttons 161, the microphone 162, the speaker 163, the vibration motor 164, the connector 165, the keypad 166, the earphone connecting jack 167, and the input unit 168. The input/output module is not limited thereto, and a cursor control such as a mouse, a trackball, a joystick, or cursor direction keys may be provided to control a movement of the cursor on the touch screen 190.

The buttons 161 are formed on the front, side or rear surface of the housing of the user terminal 100, and includes at least one of a power/lock button (not illustrated), a volume button (not illustrated), a menu button, a home button, a back button, and a search button 161.

The microphone 162 receives a voice or a sound to generate an electrical signal under the control of the controller 110.

The speaker 163 outputs sounds corresponding to various signals of the mobile communication module 120, the sub-communication module 130, the multimedia module 140, or the camera module 150 (e.g., a radio signal, a broadcasting signal, a digital audio file, a digital video file, or photographing) to the outside of the portable terminal 100 under the control of the controller 110. The speaker 163 outputs a sound (for example, a button operation sound corresponding to a phone call or a call connection sound) corresponding to a function performed by the portable terminal 100. One or more speakers 163 are formed at selected positions of the housing of the portable terminal 100.

The vibration motor 164 converts electric signals into mechanical vibrations under the control of the controller 110. For example, the vibration motor 164 operates when the portable terminal 100 in a vibration mode receives a voice call from any other device (not illustrated). One or more vibration motors 164 may be provided in the housing of the portable terminal 100, and may operate in response to a touch action of the user on the touch screen 190 and successive motions of touches on the touch screen 190.

The connector 165 may be used as an interface for connecting the portable terminal 100 with an external device (not illustrated) or a power source (not illustrated). The portable terminal 100 may transmit data stored in the storage unit 175 of the portable terminal 100 to an external device (not illustrated) or may receive data from the external device (not illustrated) through a wired cable connected to the connector 165 under the control of the controller 110. The portable terminal 100 may receive power from the power source (not illustrated) through the wired cable connected to the connector 165 or may charge a battery (not illustrated) by using the power source.

The keypad 166 receives a key input from a user for control of the portable terminal 100, and includes a physical keypad (not illustrated) formed in the portable terminal 100 or a virtual keypad (not illustrated) displayed on the touch screen 190. The physical keypad (not illustrated) formed in the portable terminal 100 may be omitted according to the capability or structure of the portable terminal 100.

Earphones (not illustrated) may be inserted into the earphone connecting jack 167 to be connected to the portable terminal 100, and the input unit 168 may be inserted into and preserved in the portable terminal 100 and may be extracted or detached from the portable terminal 100 when in use. An attachment/detachment recognition switch 169 operating in response to the attachment or detachment of the input unit 168 is provided at one area within the portable terminal 100 into which the input unit 168 is inserted, and may provide a signal corresponding to the attachment or detachment of the input unit 168 to the controller 110. The attachment/detachment recognition switch 169 is provided at one area into which the input unit 168 is inserted to directly or indirectly contact the input unit 168 when the input unit 168 is mounted. Accordingly, the attachment/detachment recognition switch 169 generates a signal corresponding to the attachment or the detachment of the input unit 168 based on the direct or indirect contact with the input unit 168, and then provides the generated signal to the controller 110.

The sensor module 170 includes at least one sensor for detecting a state of the portable terminal 100. For example, the sensor module 170 includes a proximity sensor that detects a user's proximity to the portable terminal 100, an illumination sensor (not illustrated) that detects a quantity of light around the portable terminal 100, a motion sensor (not illustrated) that detects a motion of the portable terminal 100 (e.g., rotation of the portable terminal 100 and acceleration or a vibration applied to the portable terminal 100), a geo-magnetic sensor (not illustrated) that detects a point of a compass by using Earth's magnetic field, a gravity sensor that detects an action direction of gravity, and an altimeter that detects an altitude through measurement of atmospheric pressure. The sensor module 170 may detect a position of a user's eyes or a position and a motion of a hand or the input unit 168. At least one sensor may detect a state, generate a signal corresponding to the detection, and transmit the generated signal to the controller 110. The sensor of the sensor module 170 may be added or omitted according to a capability of the portable terminal 100.

The storage unit 175 stores signals or data input/output in response to operations of the mobile communication module 120, the sub-communication module 130, the multimedia module 140, the camera module 150, the GPS module 157, the input/output module 160, the sensor module 170, and the touch screen 190 under the control of the controller 110. The storage unit 175 stores applications and control programs for control of the portable terminal 100 or the controller 110.

The term “storage unit” includes the storage unit 175, the ROM 112 and the RAM 113 within the controller 110, or a memory card (not illustrated) (for example, a Secure Digital (SD) card or a memory stick) installed in the portable terminal 100. The storage unit includes a nonvolatile memory, a volatile memory, a Hard Disk Drive (HDD), or a Solid State Drive (SSD).

The storage unit 175 may store various applications such as a navigation, a video call, a game, a time-based alarm application; images for providing a Graphical User Interface (GUI) related to the applications; a database or data related to methods for processing user information, documents, and a touch input; background images (e.g., a menu screen, a standby screen, etc.) or operating programs required for operating the portable terminal 100; and images photographed by the camera module 150. The storage unit 175 stores 3D coordinate information of a spatial gesture input detected by the touch screen. The storage unit 175 is a machine (e.g., a computer) readable medium, which is for providing data to the machine so that the machine performs a specific function. The machine readable medium may be storage medium. The storage unit 175 includes a non-volatile medium and a volatile medium. All of these media should be of a type that allows commands transferred by the media to be detected by a physical mechanism through which the machine reads the commands.

The machine readable medium includes at least one of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash-EPROM, without being limited thereto.

The power supply unit 180 may supply power to one or more batteries (not illustrated) disposed in the housing of the portable terminal 100 under the control of the controller 110. The one or more batteries (not illustrated) supply power to the portable terminal 100. The power supply unit 180 may supply, to the portable terminal 100, the power input from an external power source (not illustrated) through the wired cable connected with the connector 165. The power supply unit 180 may also supply power wirelessly input from the external power source through a wireless charging technology to the portable terminal 100.

The portable terminal 100 includes at least one touch screen providing user interfaces corresponding to various services (for example, a phone call, data transmission, broadcasting, and photography) to the user. Each touch screen may transmit an analog signal corresponding to at least one touch input to the user interfaces to a corresponding touch screen controller. The touch screens are provided with a touch screen controller that receives an analog signal corresponding to a touch. The touch screens may be connected to a plurality of housings through hinge connections, respectively, or may be located in a housing without the hinge connection. Each of the touch screens may be formed of a transparent material, and displays a 3D object including at least one 3D diagram of a sphere, a cube, a triangular pyramid, a polyhedron, a cylinder, and a cone. The 3D object contains a plurality of points, and each point of the 3D object placed in a progress direction of an input pattern is activated as a point for unlocking the portable terminal. An unlocking pattern for unlocking the touch screen is configured with at least some of the plurality of points.

The touch screen 190 may receive at least one touch through a user's body (for example, fingers including a thumb) or a touchable input unit (for example, a stylus pen or an electronic pen). When a touch is input through a pen such as a stylus pen or an electronic pen, the touch screen 190 includes a pen recognition panel 191 that recognizes the touch input, and the pen recognition panel 191 may discern a distance between the pen and the touch screen 190 through a magnetic field. The touch screen 190 may receive a continuous motion of one touch among at least one touch. The touch screen 190 may transmit an analog signal corresponding to the continuous motion of the input touch to the touch screen controller 195.

In the present invention, the touch is not limited to contact between the touch screen 190 and the user's body or the touchable input unit, and includes non-contact (e.g., the touch may be detected without the contact between the touch screen 190 and the user's body or the touchable input unit). A detectable interval in the touch screen 190 may vary depending on a performance or a structure of the portable terminal 100, and more particularly, the touch screen 190 is configured such that values detected by a touch event and a hovering event (e.g., values including a voltage value or a current value as an analog value) may be output differently from each other, in order to differently detect the touch event through the contact between the touch screen and the user's body or the touchable input unit and the input event in a non-contact state (e.g., a hovering event). It is preferable that the touch screen 190 differently outputs detected values (for example, a current value or the like) according to a distance between a space where the hovering event is generated and the touch screen 190.

The touch screen 190 may be implemented in, for example, a resistive type, a capacitive type, an infrared type, or an acoustic wave type.

The touch screen 190 may include at least two touch screen panels, which can detect touches or close access of the user's body and the touchable input unit, respectively, in order to sequentially or simultaneously receive the inputs through the user's body and the touchable input unit. The at least two touch screen panels may provide mutually different output values to the touch screen controller, which may differently recognize the values input from the at least two touch screen panels and may identify whether the input from the touch screen 190 corresponds to the input through the user's body or the input through the touchable input unit.

More specifically, the touch screen 190 may be formed with a structure in which a panel detecting an input through the input unit 168 by using a change in an induced electromotive force and a panel detecting contact through a finger on the touch screen 190 are attached to or spaced slightly apart from each other and stacked on one another. The touch screen 190 includes a plurality of pixels and displays an image through the pixels. The touch screen 190 may use a Liquid Crystal Display (LCD), an Organic Light Emitting Diode (OLED), or a Light Emitting Diode (LED).

The touch screen 190 includes a plurality of sensors that detect a location of the input unit 168 when the input unit 168 contacts a surface of the touch screen 190 or is spaced apart from the touch screen at a predetermined distance. The plurality of sensors may be formed with a coil structure, and in a sensor layer formed of the plurality of sensors, the sensors are arranged in a predetermined pattern and form a plurality of electrode lines. The touch screen 190 may be transparent and may display a 3D image. When contact is made on the touch screen 190 through the input unit 168, a detection signal of which the wave form is changed on account of a magnetic field between the sensor layer and the input unit is generated, and the touch screen 190 transmits the generated detection signal to the controller 110. When contact is made through a finger on the touch screen 190, the touch screen 190 transmits to the controller 110 a detection signal caused by an electrostatic capacity. A distance between the input unit 168 and the touch screen 190 may be discerned through an intensity of a magnetic field generated by a coil 430. The touch screen 190 displays a 3D image that has a negative disparity to appear as if it is in a rear space of the portable terminal 100 with respect to a user's eyes, or a 3D image that has a positive disparity to appear as if it is in a front space of the portable terminal.

The touch screen controller 195 converts the analog signal received from the touch screen 190 to a digital signal (for example, X and Y coordinates) and then transmits the digital signal to the controller 110. The touch screen controller 195 compares spatial depth information and coordinates of pixels (or points) displayed as a 3D image on the touch screen 190 with a position of a user's finger or input unit, and transfers a moving distance and a moving direction of the finger or input unit to the controller 110. The touch screen controller 195 distinguishes a starting point from an ending point of a pattern by the finger or input unit and transmits the distinguished starting and ending points to the controller 110. The controller 110 controls the touch screen 190 using the digital signal received from the touch screen controller 195. The controller 110 displays the pattern on the touch screen 190 by analyzing a series of pieces of information received from the touch screen controller 195. The controller 110 may allow a short-cut icon (not illustrated) or an object displayed on the touch screen 190 to be selected or executed in response to a touch event or a hovering event. The touch screen controller 195 may also be included in the controller 110.

The touch screen controller 195 may identify a distance between a space for occurrence of a hovering event and the touch screen 190 by detecting a value (e.g., a current value) output through the touch screen 190, convert the identified distance value to a digital signal (e.g., a Z coordinate), and then provide the converted digital signal to the controller 110.

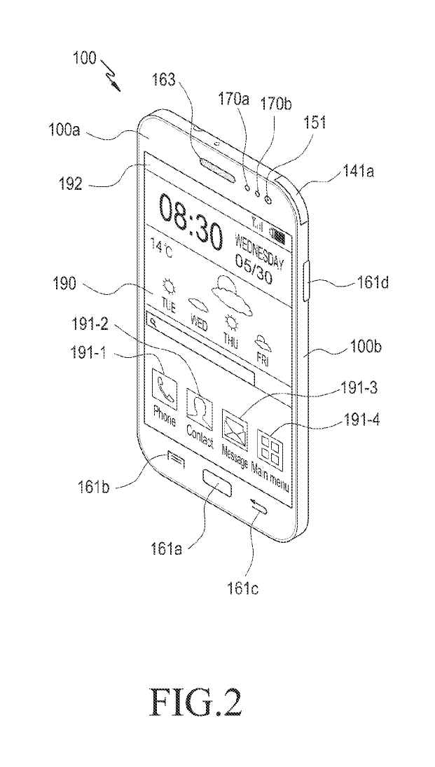

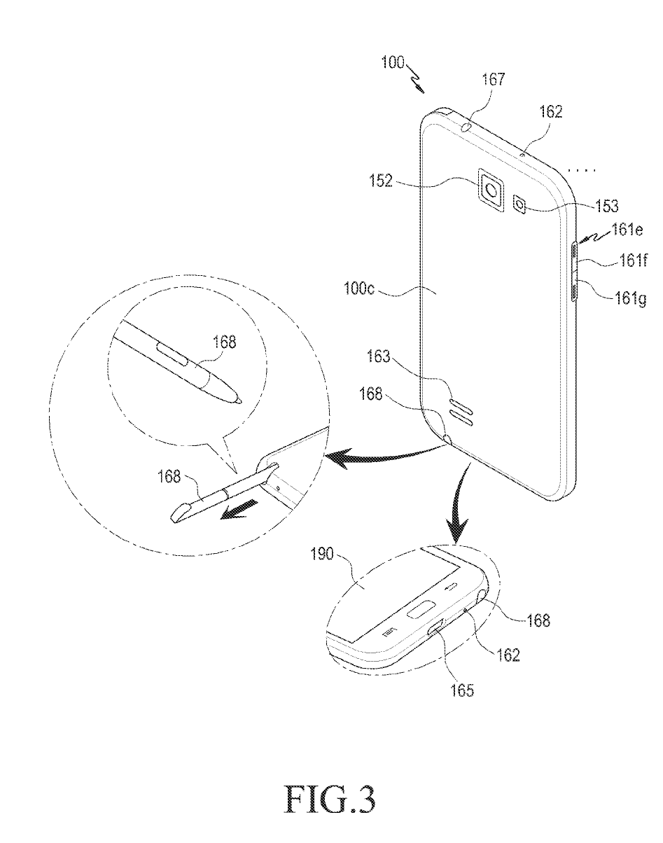

FIG. 2 illustrates a front perspective view of the portable terminal according to the embodiment of the present invention, and FIG. 3 illustrates a rear perspective view of the portable terminal according to the embodiment of the present invention.

Referring to FIGS. 2 and 3, the touch screen 190 is disposed in the center of a front surface 100a of the portable terminal 100. The touch screen 190 may have a large size to occupy most of the front surface 100a of the portable terminal 100. FIG. 2 illustrates an example in which a main home screen is displayed on the touch screen 190. The main home screen is a first screen displayed on the touch screen 190 when the portable terminal 100 is turned on. When the portable terminal 100 has different home screens of several pages, the main home screen may be a first home screen of the home screens of several pages. Shortcut icons 191-1, 191-2, and 191-3 for executing frequently used applications, a main menu switching key 191-4, time, and weather, for example, may be displayed on the home screen. The main menu switch key 191-4 displays a menu screen on the touch screen 190. On an upper end of the touch screen 190, a status bar 192 may be formed that indicates a status of the portable terminal 100 such as a battery charging status, an intensity of a received signal, and current time.

A home button 161a, a menu button 161b, and a back button 161c may be formed at a lower portion of the touch screen 190.

The main home screen is displayed on the touch screen 190 through the home button 161a. For example, when the home key 161a is touched when a home screen different from the main home screen or the menu screen is displayed on the touch screen 190, the main home screen is displayed on the touch screen 190. When the home button 191a is touched while applications are being executed on the touch screen 190, the main home screen as illustrated in FIG. 2 is displayed on the touch screen 190. The home button 161a may be used to display recently used applications or a task manager on the touch screen 190.

The menu button 161b provides a connection menu which may be displayed on the touch screen 190. The connection menu includes, for example, a widget addition menu, a background changing menu, a search menu, an editing menu, and an environment setup menu.

The back button 161c may display the screen which was executed just before the currently executed screen or may end the most recently used application.

The first camera 151, the illumination sensor 170a, and the proximity sensor 170b may be disposed on an edge of the front surface 100a of the portable terminal 100. The second camera 152, the flash 153, and the speaker 163 may be disposed on a rear surface 100c of the portable terminal 100.

For example, a power/reset button 160a, a volume button 161b, a terrestrial Digital Mobile Broadcasting (DMB) antenna 141a for reception of broadcasting, and one or more microphones 162 may be disposed on a side surface 100b of the portable terminal 100. The DMB antenna 141a is secured to the portable terminal 100 or is formed to be detachable from the portable terminal 100.

The portable terminal 100 has the connector 165 arranged on a side surface of a lower end thereof A plurality of electrodes are formed in the connector 165, which may be connected to an external device in a wired manner. The earphone connecting jack 167 may be formed on a side surface of an upper end of the portable terminal 100. Earphones may be inserted into the earphone connecting jack 167.

The input unit 168 may be mounted to a side surface of a lower end of the portable terminal 100. The input unit 168 may be inserted into and stored in the portable terminal 100, and may be withdrawn and separated from the portable terminal 100 when it is used.

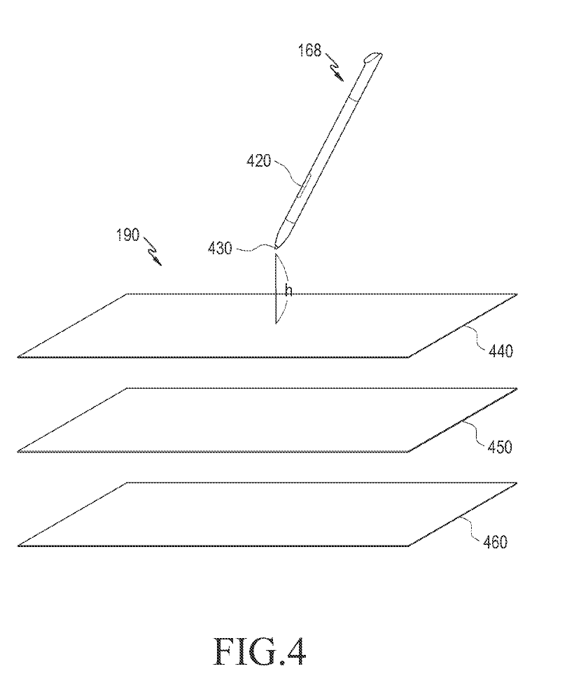

FIG. 4 illustrates an input unit and an internal structure of a touch screen according to an embodiment of the present invention.

Referring to FIG. 4, a touch screen 190 includes a first touch panel 440, a display panel 450, and a second touch panel 460. The display panel 450 may be a Liquid Crystal Display (LCD) panel or an Active Matrix Organic Light Emitting Diode (AMOLED) panel, and displays various operation statuses of a portable terminal 100, various images according to execution and a service of an application, and a plurality of objects.

The first touch panel 440 is a capacitive type touch panel, which is coated with a dielectric in which both sides of a glass are coated with a metal conductive material (e.g., an Indium Tin Oxide (ITO) film) so that the first touch panel allows a current to flow on the glass surface and stores a charge. When a user's finger is touched on a surface of the first touch panel 440, a predetermined amount of electric charge moves to a touched location due to a static electricity, and the first touch panel 440 detects the touched location through recognizing a variation in current according to the movement of the electric charge. Through the first touch panel 440, all touches that can generate static electricity may be detected and a touch by a finger or a pen which is an input unit may also be detected.

The second touch panel 460 is an Electro-Magnetic Resonance (EMR) type touch panel, which includes an electromagnetic induction coil sensor (not illustrated) having a grid structure including a plurality of loop coils arranged in a first direction and a second direction crossing the first direction, and an electronic signal processor (not illustrated) for sequentially providing an Alternating Current (AC) signal having a predetermined frequency to each loop coil of the electromagnetic induction coil sensor. When there is the pen 168 having a resonant circuit therein near the loop coil of the second touch panel 460, a magnetic field transmitted from the corresponding loop coil generates a current based on mutual electromagnetic induction to the resonant circuit within the input unit 168.

An induction magnetic field is generated, based on the current, from a coil (not illustrated) configuring a resonance circuit in the interior of an input unit 168, and the second touch panel 460 detects the induction magnetic field around the loop coil in a signal reception state to sense a hovering location or a touch location of the input unit 168, and a height (h) from the first touch panel 440 to a pen point 430 of the input unit 168. It will be readily understood by those skilled in the art to which the present invention pertains that the height (h) from the first touch panel 440 of the touch screen 190 to the pen point 430 may be varied to correspond to a performance or a structure of the portable terminal 100. If an input unit causes a current based on electromagnetic induction through the second touch panel 460, a hovering event and a touch can be detected, and it will be described that the second touch panel 460 is to be used only for detection of the hovering event or the touch by the input unit 168.

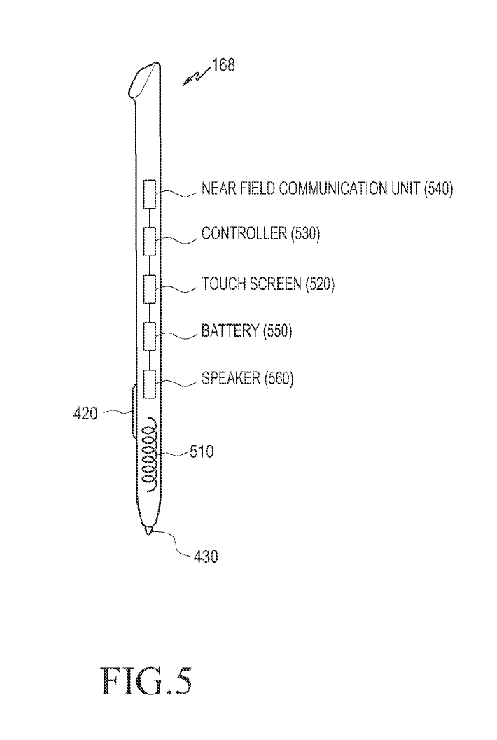

The input unit 168 may also be referred to as an electromagnetic pen or an EMR pen. The input unit 168 may be different from a general pen that does not include the resonance circuit detected through the first touch panel 440. The input unit 168 includes a button 420 that may change an electromagnetic induction value generated by a coil that is disposed, in an interior of a penholder, adjacent to the pen point 430. The input unit 168 will be more specifically described below with reference to FIG. 5.

A touch screen controller 195 includes a first touch panel controller (not illustrated) and a second touch panel controller (not illustrated). The first touch panel controller converts an analog signal received from the first touch panel 440 by a detection of a finger or pen touch to a digital signal (for example, X, Y, and Z coordinates) and transmits the converted digital signal to the controller 110. The second touch panel controller converts an analog signal, received from the second touch panel 460 through detection of a hovering event or a touch of the input unit 168, into a digital signal, and transmits the digital signal to the controller 110. The controller 110 controls the display panel 450, the first touch panel 440, and the second touch panel 460 using the digital signals received from the first and second touch panel controllers, respectively. For example, the controller 110 may display a screen in a predetermined form on the display panel 450 in response to the hovering event or the touch of the finger, the pen, or the input unit 168.

Thus, the first touch panel may sense the touch by the user's finger, and the second touch panel may sense the hovering event or the touch by the input unit 168 in the portable terminal 100. The controller 110 of the portable terminal 100 may differently sense the touch by the user's finger or the pen and the hovering event or the touch by the input unit 168. While only one touch screen is illustrated in FIG. 4, the present invention includes a plurality of touch screens, without being limited thereto. The touch screens may be disposed in housings, respectively, and may be connected with each other by hinges, or may be disposed in a single housing. The plurality of touch screens include the display panel and the at least one touch panel as illustrated in FIG. 4.

FIG. 5 illustrates an input unit according to an embodiment of the present invention.

Referring to FIG. 5, the input unit (e.g., a touch pen) includes a penholder; a pen point 430 disposed at an end of the penholder, a button 420 that may change an electromagnetic induction value generated by a coil 510 that is disposed, in an interior of the penholder, adjacent to the pen point 430, a vibration element 520 that vibrates when an hovering input effect is generated, a controller 530 that analyzes a control signal received from a portable terminal 100 due to the hovering over the portable terminal 100, and controls a vibration intensity and a vibration period of the vibration element 520 in order to provide, to the input unit 168, a vibration according to the analysis, a near field communication unit 540 that performs near field communication with the portable terminal 100, and a battery 550 that supplies an electrical power for the vibration of the input unit 168. The input unit 168 includes a speaker 560 that outputs a sound corresponding to the vibration intensity and/or the vibration period.

The speaker 560 may output, under control of the controller 530, sounds corresponding to various signals (e.g., a wireless signal, a broadcasting signal, a digital audio file, and a digital video file) received from the mobile communication module 120, the sub-communication module 130, or the multimedia module 140 which is installed in the portable terminal 100. The speaker 560 may output sounds corresponding to functions that the portable terminal 100 performs (e.g., a button manipulation tone corresponding to a telephone call, or a call connection tone), and one or more speakers 560 may be installed at a proper location of a housing of the input unit 168.

When the pen point 430 contacts the touch screen 190 and is located at a location where hovering may be detected, the controller 530 analyzes at least one control signal received from the portable terminal 100 through the near field communication unit 540, and controls the vibration period and the vibration intensity of the vibration element 520, which is provided to the input unit 168, in response to the analyzed control signal. The near field communication unit 540 and the vibration element 520 are activated before reception of the control signal. The control signal is a signal transmitted by the portable terminal 100, and is periodically or aperiodically received from the portable terminal for a period of time or until a touch on a text or picture using the input unit is completed.

The control signal is transmitted to the input unit 168 by at least one of the mobile communication module 120 and the sub-communication module 130 of the portable terminal 100. The control signal includes at least one of information for activating the vibration element of the input unit 168, representing the vibration intensity of the input unit 168, deactivating the vibration element of the input unit 168, and representing a total time for which the vibration effect is provided.

The input unit 168 having the configuration as described above supports an electrostatic induction type. When a magnetic field is caused by the coil 510 at a point of the touch screen 190, a touch screen 190 is configured to recognize a touch point by detecting a location of the corresponding magnetic field.

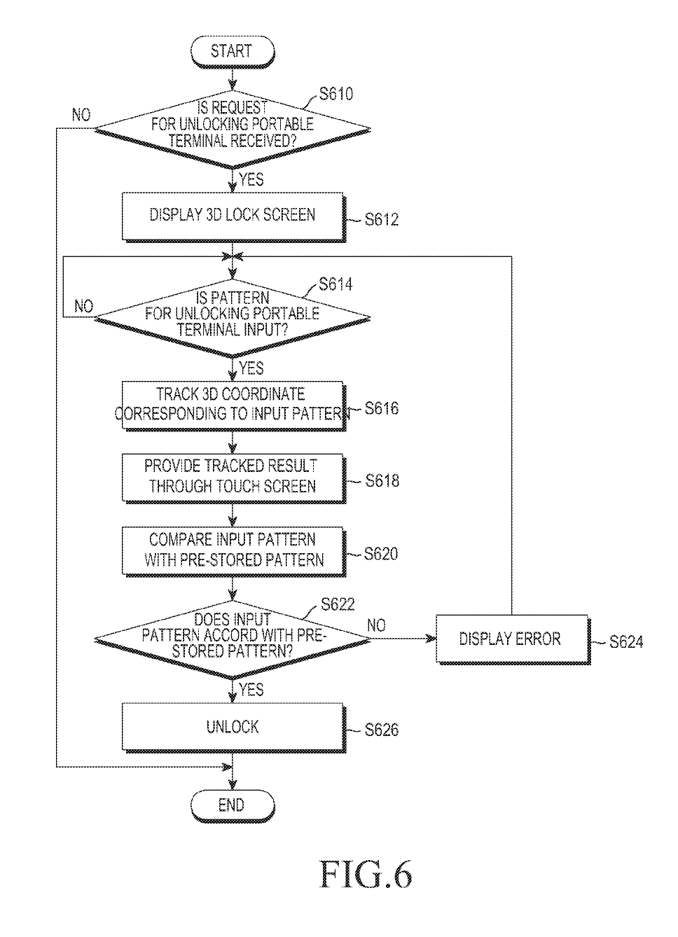

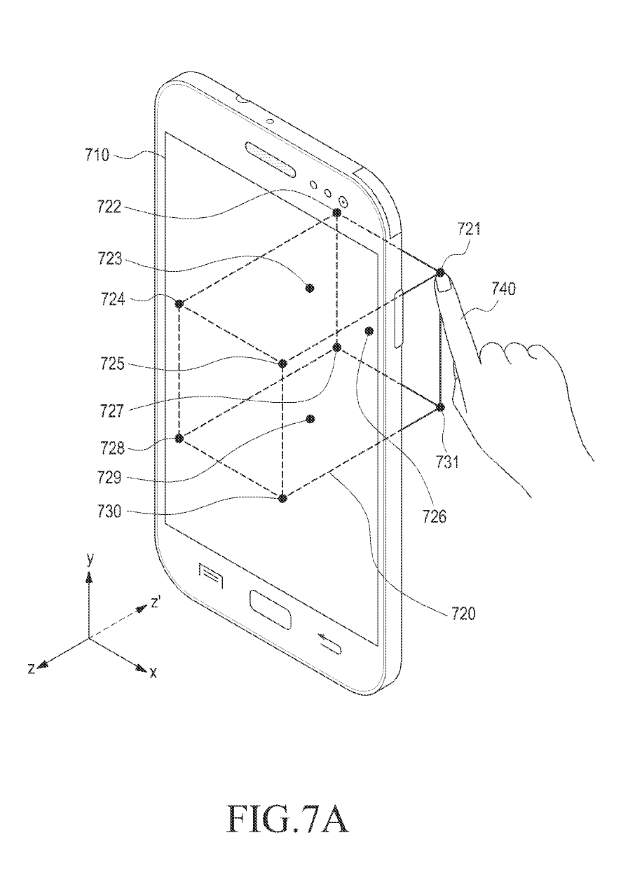

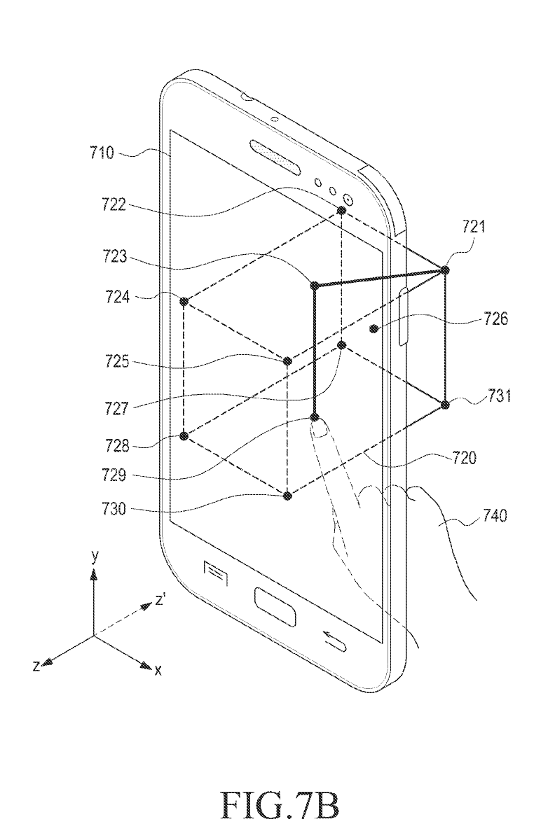

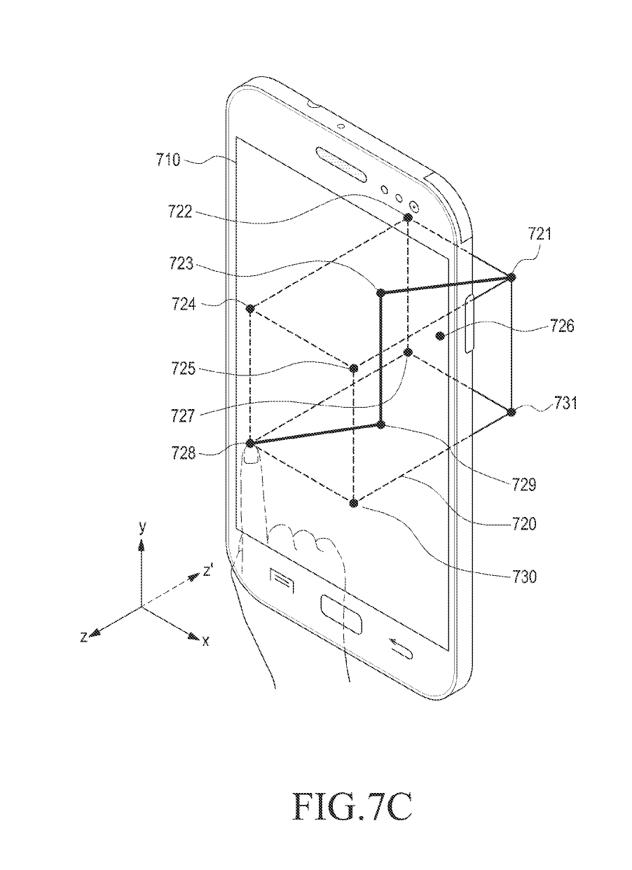

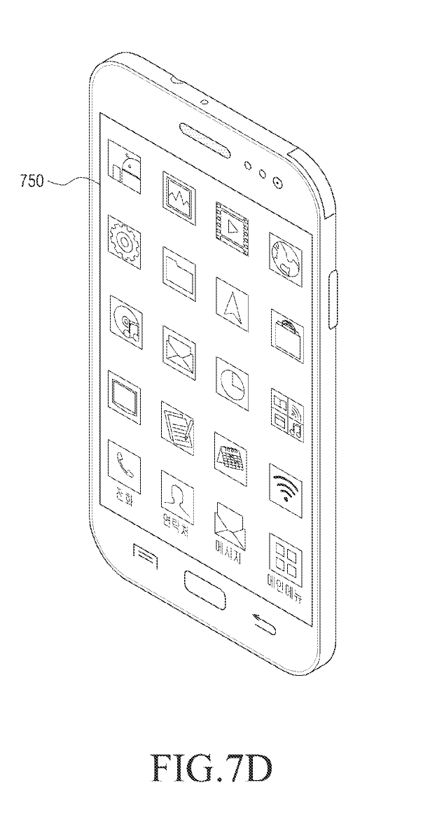

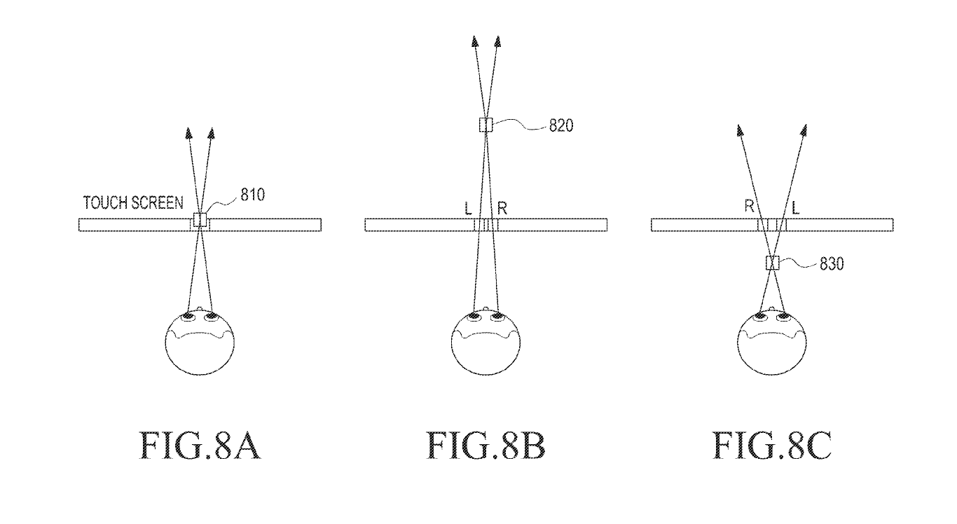

FIG. 6 illustrates a process of unlocking a portable terminal by inputting a pattern to a lock screen displayed as a 3D image according to an embodiment of the present invention, FIGS. 7A to 7D illustrate an example of an operation of unlocking a portable terminal by inputting a pattern to a lock screen displayed as a 3D image according to an embodiment of the present invention, and FIGS. 8A to 8C illustrate examples of a disparity according to a focus position where a user keeps eyes on a touch screen according to an embodiment of the present invention.

FIG. 7A illustrates an example of displaying a 3D image for unlocking the portable terminal on a touch screen according to an embodiment of the present invention, FIG. 7B illustrates an example of inputting a pattern for unlocking the portable terminal to the 3D image displayed on the touch screen according to an embodiment of the present invention, FIG. 7C illustrates an example in which the pattern for unlocking the portable terminal is completely input to the 3D image displayed on the touch screen according to an embodiment of the present invention, and FIG. 7D illustrates an example of a state in which the portable terminal is unlocked by completing the input of the pattern for the unlocking to the 3D image displayed on the touch screen according to an embodiment of the present invention.

Hereinafter, the process of unlocking the portable terminal by inputting the pattern to the lock screen displayed as the 3D (3D) image according to the embodiment of the present invention will be described in detail with reference to FIGS. 6 to 8C.

When a request for unlocking the portable terminal is received, a touch screen 190 displays a 3D lock screen in steps S610 and S612. The touch screen 190 is formed of a transparent material and displays the 3D lock screen. The 3D lock screen may be recognized in 3D by a user's binocular disparity and is focused on a front or rear side of the touch screen or the screen. The 3D lock screen includes a 3D object that is included in the 3D lock screen and includes at least one 3D object of a sphere, a cube, a triangular pyramid, a polyhedron, a cylinder, and a cone.

In the present invention, the portable terminal may be locked or unlocked using various 3D objects as well as the aforementioned 3D objects. The 3D object includes a plurality of points on an outline thereof and is placed in a progress direction of an input pattern. An unlocking pattern for unlocking the screen is configured with at least some of the plurality of points. Each point of the 3D object is activated as a point for unlocking the portable terminal. In this manner, the touch screen displays a 3D image that has a negative disparity to appear as if it is in a rear space of the touch screen or a 3D image that has a positive disparity to appear as if it is in a front space of the touch screen.

When a specific condition is satisfied, the portable terminal 100 in the locked state displays a lock screen for a user interface. Such a specific condition includes various cases such as activation of a touch screen, an input of a specific key, telephone-call or message reception, and an alarm. In the present invention, various conditions capable of displaying the lock screen as well as the aforementioned specific condition may be included. The lock screen is displayed in a 3D form on a transparent 3D display. The 3D form is an object shape which can be formed in 3D likewise to a box or a sphere. However, the lock screen according to the present invention includes various 3D objects as well as the aforementioned box or sphere.

Although a plurality of vertices of the cube are configured as the points in the present invention, arbitrary points or portions may be configured as the points. In addition, various 3D images (e.g, a building, or a block) may also be employed in addition to the cube. The lock screen has a plurality of points (or pixels) according to the 3D shape thereof. For example, when the 3D object is a cube, respective vertices thereof may be configured as the points. The respective points may be displayed in a 3D space, and a 3D distance between the points may be represented as a positive disparity or negative disparity. When the request for unlocking the portable terminal is received, a 3D image to be displayed on the lock screen is determined and displayed. Spatial coordinates are loaded for the plurality of points configured on the lock screen, and the touch screen is activated to receive a pattern for unlocking the portable terminal.

FIG. 7A illustrates an example of displaying a 3D image for unlocking the portable terminal on the touch screen according to an embodiment of the present invention, and the touch screen 710 displays a 3D cube 720. The cube 720 is configured with a plurality of vertices 721, 722, 724, 725, 727, 728, 730, and 731, and each of the vertices may be configured as a point. Surfaces 723, 726, and 729 of the cube 720 may be configured as the point. Such a point may be used to detect one point of an input pattern. The vertices 724, 725, 728, and 730 of a front surface of the cube have a positive disparity as compared with the vertices 721, 722, 727, and 731 of a rear surface of the cube. In contrast, the vertices 721, 722, 727, and 731 of the rear surface of the cube have a negative disparity as compared with the vertices 724, 725, 728, and 730 of the front surface of the cube. The positive disparity and the negative disparity may be discerned using at least one of a camera, a proximity sensor, and a hovering sensor which are provided to the portable terminal The camera may photograph a 3D image, and the photographed image includes spatial depth information.

In the present invention, the positive disparity and the negative disparity may be discerned by analyzing a focus of a user's eyes. As illustrated in FIG. 7A, while the 3D image (i.e., the cube) for unlocking the portable terminal is being displayed, an input of a preconfigured unlocking pattern is initiated from the starting point 721 using a finger 740 so as to unlock the portable terminal.

When the pattern for unlocking the portable terminal is input, 3D coordinates corresponding to the input pattern are tracked in steps S614 and S616. The touch screen according to the present invention may display the 3D image, and the gesture may be detected when a gesture is input to the 3D image. The touch screen is a transparent display device. A user may select a specific position (i.e., point) of the 3D image which has a negative disparity and is represented to be located on a rear side of the touch screen, while observing a motion of his/her finger 740 or an input unit through the touch screen. The user may select a specific position (i.e., point) of the 3D image which has a positive disparity and is represented to be located on a front side of the touch screen.

Although the cube 720 is displayed on the rear surface of the touch screen 710 of the portable terminal to have the negative disparity, a 3D diagram such as the cube may be displayed on the front surface of the portable terminal through the touch screen which can display the 3D image. When a gesture is input to the 3D image displayed on the touch screen through the finger 740 or the input unit, the portable terminal displays a trace of the gesture on the touch screen, and simultaneously tracks spatial depth information and coordinates for the respective points of the 3D image. When a drag is input, a focus of a user's eyes also moves in a desired direction, in which case a camera detects the focus of the eyes. The pattern (i.e., gesture) for unlocking the portable terminal using the finger 740 may appear as a gesture of wiggling one's index finger in the air.

FIG. 7B illustrates an example of a process of inputting the pattern for unlocking the portable terminal to the 3D image displayed on the touch screen according to an embodiment of the present invention, and a gesture is made from the first point 721 to the third point 729 by way of the second point 723 using the finger 740 on the touch screen 710. When a user locates his/her finger at the point to be selected as the starting point of the unlocking pattern among the plurality of points, the finger is detected using at least one of the camera, the proximity sensor, and the hovering sensor. When it is determined that the finger has stopped moving, a touch screen controller transmits the corresponding frame to a controller so as to obtain coordinates of the ending point indicated by the finger. The frame may be transmitted in units of predetermined time intervals.

When the coordinates of the finger received from the touch screen controller coincide with spatial depth information and coordinates of one of the 3D points of the lock screen, the controller recognizes the point as a starting point. When the gesture is made as described above, a first camera of the portable terminal detects a focus of the user's eyes and analyzes a disparity of the points to correspond to a direction in which the focus moves. A sensor module of the portable terminal may analyze the gesture which is made using the finger 740, by calculating a distance between the portable terminal and the finger 740. The portable terminal may analyze the gesture by analyzing hovering according to the distance between the portable terminal and the finger 740.

FIG. 7C illustrates an example in which the pattern for unlocking the portable terminal is completely input to the 3D image displayed on the touch screen according to an embodiment of the present invention, and a continuation of the gesture which has been input in FIG. 7B is illustrated in FIG. 7C. The gesture is made toward a fourth point 728 using the finger 740 on the touch screen 710 of the portable terminal, following the first to third points 721, 723, and 729 of FIG. 7B. As described above, the user inputs the gesture using the finger 740 or the input unit so as to draw the pattern stored in advance, in which case, if the user's drag is generated after the starting point is recognized, the camera of the portable terminal records a change in the 3D position corresponding to the drag as 3D coordinates according to a predetermined time period. The controller compares the values transferred from the camera for a moving distance and a moving direction of the finger 740 or the input unit with 3D coordinates of the plurality of points, and if there is a point on a trace along which the finger or the input unit has moved, determines to select the corresponding point.

The controller displays the trace as a moving path on the screen, in which the moving path indicates a spatial moving path. In addition, the sensor module of the portable terminal may analyze the gesture which is made using the finger 740, by calculating a distance between the portable terminal and the finger 740. The portable terminal may analyze the gesture by analyzing hovering according to the distance between the portable terminal and the finger 740.

Although the touch screen 190 displays the 3D lock screen as if the 3D lock screen is located on the rear surface of the portable terminal in FIGS. 7A to 7C, the touch screen 190 according to the present invention may display the 3D lock screen as if the 3D lock screen is located on the front surface of the portable terminal. In this case, the user may input the pattern for unlocking or locking the portable terminal on the front surface of the portable terminal.

In the present invention, the portable terminal may be three-dimensionally unlocked as described above, and may also be three-dimensionally locked. The portable terminal may be locked or unlocked at least one or more times by alternately displaying the 3D lock screen as if located on the front or rear surface of the portable terminal.

FIGS. 8A to 8C illustrate examples of a disparity according to a focus position where a user keeps eyes focused on the touch screen according to an embodiment of the present invention, and a 3D object may be displayed through a touch screen for displaying a 3D image as if located on a rear or front side of the portable terminal. The 3D image may be displayed as if located on the touch screen. FIG. 8A illustrates an example in which a 3D object 810 is displayed as if located on the touch screen, FIG. 8B illustrates an example in which a 3D object 820 is displayed as if located on the rear side of the touch screen, and FIG. 8C illustrates an example in which a 3D object 830 is displayed as if located on the front side of the touch screen. The touch screen 190 according to the present invention may be a transparent display device and may display the 3D object, to give a user the impression of watching a 3D movie.

Referring back to FIG. 6, the pattern input in step S614 is provided through the touch screen in step S618. When the pattern is input in step S614, the portable terminal 100 allows the user to recognize that the pattern is initiated, by changing a color of the starting point of the pattern. In the present invention, the user may recognize the start of the pattern through various methods using a sound or haptic feedback in addition to the color. As described above, when the pattern for unlocking the portable terminal is input, the portable terminal displays the input pattern through the touch screen as illustrated in FIGS. 7B and 7C.

The controller 110 compares the pattern which has been input in step S614 with a pre-stored pattern in step S620. The controller 110 analyzes the spatial gesture input based on the 3D coordinate information of the 3D lock screen displayed on the touch screen. Specifically, if it is identified that there is a point on 3D spatial coordinates dragged using the finger or the input unit, the controller determines the coordinates corresponding to the point as an input for the corresponding point and performs a comparison with the lock pattern. The controller compares information on a type and a selection order of the selected points with a pattern password stored in advance as an unlocking condition.

As a result of the comparison, if the information does not coincide with the pattern password, the controller displays an error message informing that the input pattern does not match the encrypted pattern in steps S622 and S624, and then returns to step S614. When the spatial gesture input does not coincide with the encrypted pattern (i.e., the unlocking pattern), the controller maintains the portable terminal in the locked state. When the input pattern does not coincide with the pre-stored encrypted pattern or the pattern is not completely input for a predetermined time interval or more, the controller informs the user of the error. Means for informing of the error includes one or more of a sound, a vibration, and a text. When the user's finger stops or escapes from the 3D image to an external area during the input of the pattern, the controller may determine that the password pattern is completely input.

If it is determined in step S622 that the spatial gesture input coincides with the encrypted pattern, the controller unlocks the portable terminal in step S626. As a result of the comparison, if the spatial gesture input coincides with the encrypted pattern, this means that the input pattern matches the pre-stored pattern, in which case the portable terminal is unlocked. When the spatial gesture input coincides with the unlocking pattern, the controller unlocks the portable terminal. In addition, the controller configures the portable terminal as the unlocked state, and displays a home screen, received texts, or a corresponding alarm screen.

FIG. 7D illustrates the state in which the portable terminal is unlocked by the pattern input in FIGS. 7B and 7C, and a touch screen 750 of FIG. 7D displays a screen configured in advance by the user.

It may be appreciated that embodiments of the present invention may be implemented in software, hardware, or a combination thereof. Any such software may be stored, for example, in a volatile or non-volatile storage device such as a ROM, a memory such as a RAM, a memory chip, a memory device, or an IC, or a optical or magnetic recordable and machine (e.g., computer) readable medium such as a CD, a DVD, a magnetic disk, or a magnetic tape, regardless of its ability to be erased or its ability to be re-recorded. It will be appreciated that a memory, which may be incorporated in a portable terminal, may be an example of a machine-readable storage medium which is suitable for storing a program or programs including commands to implement the embodiments of the present invention. Accordingly, the present invention includes a program that includes a code for implementing an apparatus or a method defined in any claim in the present specification and a machine-readable storage medium that stores such a program. The program may be electronically transferred by a predetermined medium such as a communication signal transferred through a wired or wireless connection, and the present invention appropriately includes equivalents of the program.

The above-described mobile terminal can receive the program from a program provision device which is connected thereto in a wired or wireless manner, and store the program. The program providing device includes a program including instructions allowing the portable terminal to perform the unlocking operation, a memory for storing information required for the unlocking operation, a communication unit for performing wired or wireless communication with the portable terminal, and a controller transmitting a corresponding program to the host device according to a request of the portable terminal or automatically.

Although specific embodiments have been described in the detailed descriptions of the present invention, it is apparent that various modifications may be carried out without departing from the scope of the present invention. Therefore, the scope of the present invention should not be defined as being limited to the embodiments, but should be defined by the appended claims and equivalents thereof.

What is claimed is:

1. A method for unlocking a portable terminal, the method comprising:
displaying a Three Dimensional (3D) lock screen recognized in 3D on a screen; and
determining a locking state of the portable terminal based on a spatial gesture input if the spatial gesture input is detected on the 3D lock screen.

2. The method of claim 1, further comprising detecting the spatial gesture input using at least one of a camera that is provided to the portable terminal and photographs a 3D image, a proximity sensor that measures a distance away from the portable terminal, and a hovering sensor.

3. The method of claim 1, further comprising:
displaying a trace of the spatial gesture input on the 3D lock screen.

4. The method of claim 3, further comprising:
outputting at least one of a change in a color of at least one portion of the 3D lock screen, a sound, and haptic feedback while displaying the trace.

5. The method of claim 1, wherein determining the locking state comprises:
analyzing the spatial gesture input based on 3D coordinate information of the 3D lock screen displayed on the screen.

6. The method of claim 1, wherein the 3D lock screen displayed on the screen includes an image recognized in 3D by a binocular disparity of a user's eyes, and is focused on a front or rear side of the screen.

7. The method of claim 1, wherein the screen is transparent and displays a 3D object.

8. The method of claim 1, wherein the 3D lock screen comprises a 3D object that includes at least one of a sphere, a cube, a triangular pyramid, a polyhedron, a cylinder, and a cone.

9. The method of claim 8, wherein the 3D object includes a plurality of points, and
wherein an unlocking pattern for unlocking the screen is configured with at least some of the plurality of points.

10. The method of claim 1, further comprising:
comparing 3D coordinates of the spatial gesture input with 3D coordinates of a pre-stored unlocking pattern.

11. The method of claim 10, further comprising:
maintaining the portable terminal in a locked state if the spatial gesture input does not correspond to the unlocking pattern.

12. The method of claim 11, further comprising:
informing that the spatial gesture input does not correspond to the unlocking pattern using one or more of a sound, a vibration, and a text if the spatial gesture input is not in accordance with the unlocking pattern.

13. The method of claim 10, further comprising:
unlocking the portable terminal if the spatial gesture input does not correspond to the unlocking pattern.

14. A portable terminal for unlocking a touch screen, the portable terminal comprising:
a screen configured to display a Three Dimensional (3D) lock screen recognized in 3D; and
a controller configured to control a locking state of the portable terminal based on a spatial gesture input if the spatial gesture input is detected on the 3D lock screen.

15. The portable terminal of claim 14, wherein the controller detects the spatial gesture input using at least one of a camera that is provided to the portable terminal and photographs a 3D image, a proximity sensor that measures a distance away from the portable terminal, and a hovering sensor.

16. The portable terminal of claim 14, wherein the controller displays a trace of the spatial gesture input on the 3D lock screen.

17. The portable terminal of claim 14, wherein the controller analyzes the spatial gesture input based on 3D coordinate information of the 3D lock screen displayed on the screen.

18. The portable terminal of claim 14, wherein the 3D lock screen displayed on the screen is an image recognized in 3D by a binocular disparity of a user's eyes, and is focused on a front or rear side of the screen.

19. The portable terminal of claim 14, wherein the screen is transparent and displays a 3D object.

20. The portable terminal of claim 14, wherein the 3D lock screen comprises a 3D object that includes at least one of a sphere, a cube, a triangular pyramid, a polyhedron, a cylinder, and a cone.

21. The portable terminal of claim 20, wherein the 3D object includes a plurality of points, and
wherein an unlocking pattern for unlocking the screen is configured with at least some of the plurality of points.

22. The portable terminal of claim 14, wherein the controller compares 3D coordinates of the spatial gesture input with 3D coordinates of a pre-stored unlocking pattern.

23. The portable terminal of claim 22, wherein the controller maintains the portable terminal in a locked state if the spatial gesture input does not correspond to the unlocking pattern.

24. The portable terminal of claim 23, wherein the controller informs that the spatial gesture input does not correspond to the unlocking pattern using one or more of a sound, a vibration, and a text if the spatial gesture input is not in accordance with the unlocking pattern.

25. The portable terminal of claim 22, wherein the controller unlocks the portable terminal if the spatial gesture input does not correspond to the unlocking pattern.

26. A method for locking a portable terminal, the method comprising:
displaying a Three Dimensional (3D) lock screen recognized in 3D on a screen to lock the portable terminal; and
determining a lock configuration of the portable terminal based on a spatial gesture input if the spatial gesture input is detected on the 3D lock screen.

27. The method of claim 26, further comprising detecting the spatial gesture input using at least one of a camera that is provided to the portable terminal and photographs a 3D image, a proximity sensor that measures a distance away from the portable terminal, and a hovering sensor.

28. The method of claim 26, further comprising:
displaying a trace of the spatial gesture input on the 3D lock screen.

29. The method of claim 28, further comprising:
outputting at least one of a change in a color of at least one portion of the 3D lock screen, a sound, and haptic feedback while displaying the trace.

30. The method of claim 26, wherein the determining of the locking state comprises:
analyzing the spatial gesture input based on 3D coordinate information of the 3D lock screen displayed on the screen.

31. The method of claim 30, further comprising:
storing the detected spatial gesture input based on the 3D coordinate information.

32. The method of claim 26, wherein the 3D lock screen comprises a 3D object, and the 3D object comprises at least one of a sphere, a cube, a triangular pyramid, a polyhedron, a cylinder, and a cone.

33. A portable terminal for locking a screen, comprising:
a screen configured to display a three dimensional (3D) lock screen recognized in 3D in response to a menu that is executed to lock the portable terminal; and
a controller configured to determine a lock configuration of the portable terminal based on a spatial gesture input if the spatial gesture input is detected on the 3D lock screen.

34. The portable terminal of claim 33, wherein the controller detects the spatial gesture input using at least one of a camera that is provided to the portable terminal and photographs a 3D image, a proximity sensor that measures a distance away from the portable terminal, and a hovering sensor.

35. The portable terminal of claim 33, wherein the controller displays a trace of the spatial gesture input on the 3D lock screen.

36. The portable terminal of claim 35, wherein the controller outputs at least one of a change in a color of at least one portion of the 3D lock screen, a sound, and haptic feedback while displaying the trace.

37. The portable terminal of claim 33, wherein the controller analyzes the detected spatial gesture input based on 3D coordinate information of the 3D lock screen displayed on the screen.

38. The portable terminal of claim 37, further comprising:
a storage unit that stores the detected spatial gesture input based on the 3D coordinate information.

39. The portable terminal of claim 33, wherein the 3D lock screen comprises a 3D object, and the 3D object comprises at least one of a sphere, a cube, a triangular pyramid, a polyhedron, a cylinder, and a cone.
